(19) United States
(12) Patent Application Publication
(10) Pub. No.: US 2003/0093293 A1
(43) Pub. Date: May 15, 2003

(54) Transaction system

(75) Inventor: Richard A. Han, Angus (GB)

Correspondence Address: MICHAEL CHAN, NCR CORPORATION, 1700 SOUTH PATTERSON BLVD, DAYTON, OH, 45479-0001, US

(73) Assignee: NCR Corporation

(21) Appl. No.: 10/261,141

(22) Filed: Sep. 30, 2002

(30) Foreign Application Priority Data
Nov. 14, 2001 (GB) 0127298.8

(51) Int. Cl. G06F 17/60

(52) U.S. Cl. 705/1

(57) ABSTRACT

There is provided a method of and an apparatus for levying a surcharge as a result of a self-service terminal transaction. The surcharge may be paid, in part or in full, to a charity.

### BACKGROUND OF THE INVENTION

This application relates to a transaction system and in particular to a method of and apparatus for the provision of a transaction service.

Financial institutions, in general, operate a number of different transaction service networks. For example, a number of financial institutions operate networks of automated teller machines (ATMs) through which a user can obtain access to an array of services from the withdrawal of cash to the provision of information or advice. Such ATM networks are well known and will not be discussed further herein.

Financial institutions, in general, desire to provide further and greater revenue from these networks without alienating the users. In an attempt to achieve this goal some financial institution levy a surcharge when they provide cash to a user who is not a customer of that financial institution. However, there is perceived to be a growing disquiet from customers who are required to pay such surcharges.

Accordingly, it would be beneficial to provide a means of providing additional revenue from financial service networks, such as ATM networks, without alienating the customers who use those networks.

### SUMMARY OF THE INVENTION

It is an object of this application to address this issue.

According to a first aspect of the present invention there is provided a method of operating a self-service transaction device that levies a surcharge on transactions performed by the device, the method being characterized by the step of donating at least a portion of the surcharge to a charitable trust.

According to a further aspect of the present invention there is provided a transaction system comprising a self-service terminal in communication with a transaction authorization host, where the terminal is operable to perform a transaction for a user and to apply a surcharge to the transaction, and the host is operable to debit an account associated with the user and to credit at least a portion of the surcharge to a third party account as a charitable donation.

According to a further aspect of the present invention there is provided a transaction system including a user operated device for performing transactions incurring a surcharge, the system being configurable for selecting a charitable organization to receive at least of a portion of a surcharge.

According to a further aspect of the present invention there is provided a method of encouraging donations to a charitable organization, the method including the steps of:

providing a financial institution with account details relating to a banking account in the name of the charitable organization;

inviting self-service terminal users to elect the charitable organization as a recipient of any portion of a surcharge applied to the users' transactions; and

informing users of the amount donated to the charitable institution as a result of the users' transactions.

According to a further aspect of the present

invention there is provided a method of motivating users to perform a transaction on a self-service terminal, despite a surcharge being applied to the transaction, the method comprising the steps of:

during a transaction, informing a user of the amount of surcharge to be applied to the transaction; and

informing the user that at least a portion of this amount will be donated to a charitable institution.

According to a further aspect of the present invention there is provided a method of operating a financial services network in order to provide a service to users thereof, in which said users are surcharged for said service, characterized in that at least a portion of the surcharge amount is donated to a charity.

According to a further aspect of the present invention there is provided a method of operating a network of Automated Teller Machines (ATM) including a plurality of ATMs and a financial institution back office computer, arranged such that a user is surcharged when withdrawing cash from any one of the ATMs in the network, characterized in that, on receipt of a signal from the ATM that a transaction has been completed the back office computer automatically, electronically transfers, at least a portion of, the surcharge amount to an account in the name of a charity.

According to a further aspect of the present invention there is provided an automated Teller Machine (ATM) network including a plurality of ATMs and a financial institution back office computer, arranged such that a user is surcharged when withdrawing cash from any one of the ATMs in the network, characterized in that, on receipt of a signal from said any one of the ATMs, that a transaction has been completed, the back office computer automatically, electronically transfers, at least a portion of, the surcharge amount to an account in the name of a charity.

According to a further aspect of the present invention there is provided a self-service terminal for use in a system method or network as described above, wherein the terminal is a self-checkout point of sale terminal, a fuel dispenser, an automated teller machine, or such like.

The term “surcharge” is used herein in the description and the associated claims, to mean any payment of money associated with the provision of a specific service. For example, this includes the payment, by a customer or user, of a small percentage or fixed fee for the withdrawal of cash from an Automated Teller Machine or for the further provision of a service such as the ordering of a check book or a bank or financial institution statement. A “surcharge” may also mean a payment made by the financial institution on behalf of the customer or user. Furthermore, a surcharge may be voluntary or may be compulsory. A surcharge may also be partly paid by the user, said payment being matched either equally or in some proportion by the financial institution. Any surcharge can be a percentage of a withdrawal and each percentage may be capped at a specific financial value, for example, five dollars. The user may also be provided with the facility to vary the amount from a predetermined minimum to a predetermined maximum. Thus a user can find a convenient way in which to provide charitable donations through an automated teller network.

### BRIEF DESCRIPTION OF THE DRAWINGS

An embodiment of the present invention will now be described, by way of example, with reference to the accompanying drawings in which:

FIG. 1 is schematic representation of your financial services network in accordance with the present invention; and

FIG. 2 is a flow diagram of a method of operation of the network of FIG. 1 in accordance with the present invention.

### DETAILED DESCRIPTION

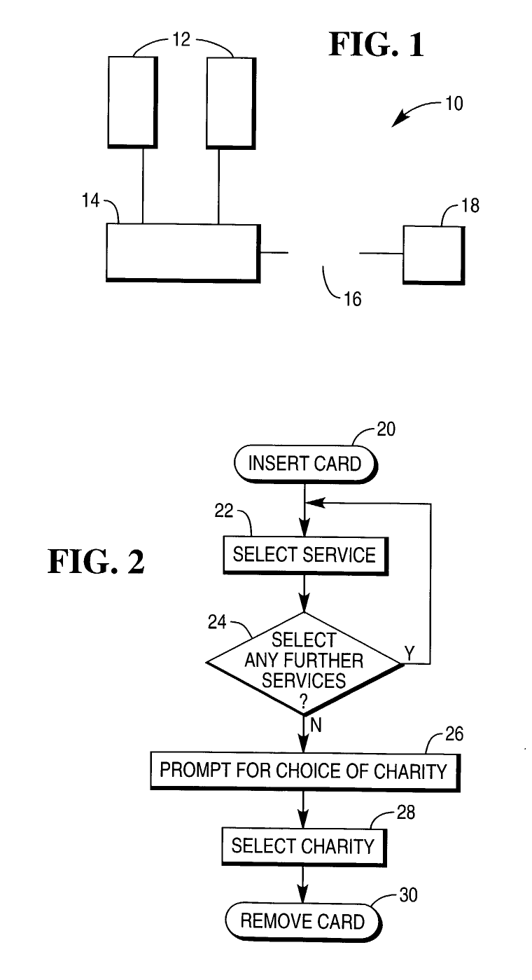

With reference to FIG. 1, there is illustrated a transaction system 10 comprising a transaction terminal, in the form of an ATM 12, and a host computer 14.

The host computer 14 is arranged both to receive authorization data from the ATMs to confirm the accuracy and validity of that data and to authorize payments such as the withdrawal of cash or the provision services. When a user withdraws cash from an ATM 12, in accordance with the present invention, the ATM 12 displays an option to the user to select one of a plurality of charities from a list of charities to which a surcharged amount will be donated. The list may include a reference for “None of the above” in which case either no surcharge will be applied or the surcharge will be applied but not donated to a charity. Alternatively, if the user selects “None of the above”, at the end of a specific time period, say each month, the user may be provided with a statement and asked at that time to which charity they wish their donations to be made. If the user selects a charity at this time the host computer 14 will either credit an account in the name of that organization within the financial network or, via the internet 16 or some other means, provide information to this effect to another host computer 18 which is known to hold an account for that charity.

One substantial technical difference between the network in accordance with the present invention and prior art surcharging is that it is not presently known to provide a user with such real time options and to await receipt of information from a user relating to those options prior to the completion of a service or transaction.

With reference to FIG. 2 there is illustrated a method of operation of an automated teller machine network 10 in accordance with the present invention. In order to operate an ATM 12 in the aforementioned network 10 a user inserts his or her card in the ATM 12 (box 20). The user then after providing authorization information to the ATM, in the normal manner, selects the service required (box 22). The ATM then run through a series of requests such as the amount of cash to be withdrawn etc. as with standard ATMs. This includes a standard final request for “any further services” (box 24). Additionally, the ATM will prompt the user to select a charity to which the surcharge will be donated (box 26). Once the user indicates that he or she does not require any further services and has selected a charity (box 28) their card will be presented for removal as with normal ATM (box 30).

Optionally the selection of a charity may include the selection of two or more charities in which case an appropriate percentage of the surcharge will be donated to each or every charity. For example, if a user selects two charities then 50% of the surcharge may be paid to each.

Modifications may be incorporated without departing from the scope of the present invention. For example a point of sales network or a network of petrol pumps could replace the ATM network. Also, charities, which are to receive donations, may be pre-selected by users either as a one-off ATM transaction or over the Internet.

What is claimed is:

1. A method of operating a self-service transaction device that levies a surcharge on transactions performed by the device, the method comprising the step of:
donating at least a portion of the surcharge to a charitable trust.

2. A transaction system comprising:
a self-service terminal including means for performing a transaction for a user and for applying a surcharge to the transaction; and
a transaction authorization host in communication with the self-service terminal, the host including means for debiting an account associated with the user and for crediting at least a portion of the surcharge to a third party account as a charitable donation.

3. A system according to claim 2, wherein the host includes means for recording for each user of the terminal the total amount donated as a result of the transactions conducted by the user, and means for informing the user of this total amount during a transaction.

4. A transaction system comprising:
a user operated device for performing transactions incurring a surcharge; and
means for selecting a charitable organization to receive at least a portion of a surcharge.

5. A method of encouraging donations to a charitable organization, the method comprising the steps of:
providing a financial institution with account details relating to a banking account in the name of the charitable organization;
inviting self-service terminal users to elect the charitable organization as a recipient of any portion of a surcharge applied to the users' transactions; and
informing users of the amount donated to the charitable institution as a result of the users' transactions.

6. A method of motivating users to perform a transaction on a self-service terminal, despite a surcharge being applied to the transaction, the method comprising the steps of:
during a transaction, informing a user of the amount of surcharge to be applied to the transaction; and
informing the user that at least a portion of this amount will be donated to a charitable institution.

7. A method of operating a financial services network, the method comprising the steps of:
providing a service to users of the financial services network; and
donating at least a portion of the surcharge amount to a charity.

8. A method according to claim 7, wherein individual users determine the charity to which their surcharge amount is paid.

9. A method according to claim 8, wherein the service comprises the withdrawal of cash.

10. A method according to claim 9, wherein the network comprises an Automated Teller Machine (ATM) network.

11. A method according to claim 10, wherein the charity is selected from a list of charities presented to each user by ATMs within the network.

12. A method according to claim 7, wherein the network comprises an Automated Teller Machine (ATM) network.

13. A method of operating a network of Automated Teller Machines (ATM) including a plurality of ATMs and a financial institution back office computer, arranged such that a user is surcharged when withdrawing cash from any one of the ATMs in the network, the method comprising the steps of:
receiving at the back office computer a signal from an ATM that a transaction has been completed; and
the back office computer automatically, electronically transferring at least a portion of the surcharge amount to an account in the name of a charity.

14. A method according to claim 13, wherein the signal from the ATM includes an indication of the charity to which the donation is to be paid.

15. An Automated Teller Machine (ATM) network including a plurality of ATMs and a financial institution back office computer, arranged such that a user is surcharged when withdrawing cash from any one of the ATMs in the network, the ATM network comprising:
means for receiving at the back office computer a signal from any one of the ATMs that a transaction has been completed; and
the back office computer including means for automatically, electronically transferring at least a portion of the surcharge amount to an account in the name of a charity.

16. A network as claimed in claim 15, wherein the signal from the ATM includes an indication of the charity to which the donation is to be paid.

17. A self-service terminal comprising:
means for enabling a user to carry out a transaction;
means for charging the user a surcharge amount in connection with the transaction; and
means for donating at least a portion of the surcharge amount to a charity.

18. A self-service terminal according to claim 17, further comprising means for enabling the user to select the charity to which a donated portion of the surcharge amount is to be paid.

19. An automated teller machine (ATM) comprising:
a cash dispenser for dispensing cash to an ATM customer;
means for enabling the ATM customer to carry out an ATM transaction withdrawing cash;
means for charging the ATM customer a surcharge amount in connection with the ATM transaction withdrawing cash; and
means for donating at least a portion of the surcharge amount to a charity.

20. An ATM according to claim 19, further comprising means for enabling the ATM customer to select the charity to which a donated portion of the surcharge amount is to be paid.
